(19) United States
(12) Patent Application Publication
(10) Pub. No.: US 2010/0226227 A1
(43) Pub. Date: Sep. 9, 2010

(54) METHODS AND APPARATUSES OF PROCESSING READBACK SIGNAL GENERATED FROM READING OPTICAL STORAGE MEDIUM

(76) Inventors: Chih-Ching Yu, Hsinchu City (TW); Ying-Feng Huang, Chia-Yi Hsien (TW); Ya-Fang Nien, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 12/400,782

(22) Filed: Mar. 9, 2009

(51) Int. Cl. G11B 20/18

(52) U.S. Cl. 369/53.15; G9B/20.046

(57) ABSTRACT

A method of processing a readback signal generated from reading an optical storage medium is provided. The method includes: performing a defect detection according to the readback signal to generate a defect detection result indicating defective areas on the optical storage medium; and performing a parameter calibration upon at least a parameter associated with processing of the readback signal according to the defect detection result.

### BACKGROUND

The disclosed embodiments relate to methods and apparatuses of processing readback signal generated from reading optical storage medium.

Optical storage media, such as read-only, recordable, or rewritable optical discs, have become popular data carriers nowadays. In general, the stored data are reproduced from reading a recording layer (i.e., a reflective layer) of an optical storage medium through directing a laser beam onto the recording layer and then detecting signals reflected from the recording layer. To protect the recording layer (reflective layer), a protective layer made of, for example, polycarbonate is generally formed on the recording layer. Therefore, the laser beam emitted from a laser diode has to pass through the protective layer before arriving at the recording layer (i.e., the reflective layer); similarly, the laser beam reflected from the recording layer (i.e., the reflective layer) has to pass through the protective layer before being detected by a photo sensor. Therefore, the signal quality of the reflected laser beam detected by the photo sensor is actually affected by the protective layer.

However, an optical disc might have a defective area due to scratch, dirt, or fingerprint on a surface of the protective layer. Please refer to FIG. 1, which is a diagram illustrating a radio frequency (RF) signal generated from signals reflected from an optical disc having a defective area formed due to scratch. When there is a scratch formed on a protective layer of an optical disc, the scratch would seriously damage the light transmission characteristic of the protective layer. As one can see, the RF signal RF_1 has a signal portion P1 that almost disappears (i.e., the signal amplitude is quite low) when an optical pick-up head is emitting a laser beam toward a defective area caused by the scratch. As a result, it is difficult to decode such a signal portion P1 of the RF signal correctly.

Please refer to FIG. 2, which is a diagram illustrating an RF signal generated from signals reflected from an optical disc having a defective area due to fingerprint or dirt. When there is a fingerprint or dirt on a protective layer of an optical disc, the fingerprint/dirt does not seriously damage the light transmission characteristic of the protective layer. As one can see, the RF signal RF_2 has a signal portion P2 with a magnitude smaller than normal one when an optical pick-up head is emitting a laser beam toward a defective area caused by the fingerprint/dirt. Because the signal portion P2, compared to the signal portion P1 in FIG. 1, does not disappear completely (i.e., the signal amplitude is reduced but is still above an acceptable level), there might be a chance to decode the signal portion P2 for deriving the information transmitted by the signal portion P2. However, it is still possible that the decoding of the signal portion P2 fails when the signal quality of the signal portion P2 does not meet the minimum decoding requirement.

Please refer to FIG. 3, which is a diagram illustrating another RF signal generated from signals reflected from an optical disc having a defective area due to fingerprint or dirt. As one can see, the RF signal RF_3 has a signal portion P3 with significant magnitude variation when an optical pick-up head is emitting a laser beam toward a defective area caused by the fingerprint/dirt. Similarly, because the signal portion P3, compared to the signal portion P1 in FIG. 1, does not disappear completely (i.e., the signal amplitude is reduced but is still above an acceptable level), there might be a chance to decode the signal portion P3 for deriving the information transmitted by the signal portion P3.

As mentioned above, the RF signal affected by the fingerprint/dirt does not disappear completely. Therefore, how to process the RF signal affected by the fingerprint/dirt for allowing the following decoding process to correctly derive information from the RF signal affected by the fingerprint/dirt becomes an important issue for designers. In other words, there is a need of a method and apparatus to improve performance of reading defective areas on the optical storage medium, especially the defective areas caused by fingerprint/dirt.

### SUMMARY

In accordance with exemplary embodiments of the present invention, the present invention provides methods and apparatuses of processing a readback signal (e.g., an RF signal) generated from reading an optical storage medium (e.g., an optical disc) for improving performance of reading defective areas on the optical storage medium.

According to a first aspect of the present invention, an exemplary method of processing a readback signal generated from reading an optical storage medium is provided. The method includes: performing a defect detection according to the readback signal to generate a defect detection result indicating defective areas on the optical storage medium; and performing a parameter calibration upon at least a parameter associated with processing of the readback signal according to the defect detection result.

According to a second aspect of the present invention, an exemplary apparatus for processing a readback signal generated from reading an optical storage medium is provided. The apparatus includes a defect detection block and a parameter calibration block. The defect detection block is implemented for performing a defect detection according to the readback signal to generate a defect detection result indicating defective areas on the optical storage medium. The parameter calibration block is coupled to the defect detection block, and implemented for performing a parameter calibration upon at least a parameter associated with processing of the readback signal according to the defect detection result.

According to a third aspect of the present invention, a method of processing a readback signal generated from reading an optical storage medium is provided. The method includes: deriving identification information of the optical storage medium according to the readback signal; performing a parameter calibration upon at least one parameter associated with processing of the readback signal, thereby deriving a calibrated parameter setting; and recording the calibrated parameter setting indexed by the identification information in a storage device.

According to a fourth aspect of the present invention, an apparatus for processing a readback signal generated from reading an optical storage medium is provided. The apparatus includes an optical storage access block, a parameter calibration block, a storage device, and a control block. The optical storage access block is implemented for deriving the readback signal and deriving identification information of the optical storage medium according to the readback signal. The parameter calibration block is coupled to the optical storage access block, and is implemented for performing a parameter calibration upon at least one parameter associated with processing of the readback signal, thereby deriving a calibrated parameter setting. The control block is coupled to the calibration block, the optical storage access block and the storage device, and is implemented for recording the calibrated parameter setting indexed by the identification information in the storage device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a radio frequency (RF) signal generated from signals reflected from an optical disc having a defective area due to scratch.

FIG. 2 is a diagram illustrating an RF signal generated from signals reflected from an optical disc having a defective area due to fingerprint or dirt.

FIG. 3 is a diagram illustrating another RF signal generated from signals reflected from an optical disc having a defective area due to fingerprint or dirt.

FIG. 4 is a block diagram illustrating an optical storage apparatus according to an exemplary embodiment of the present invention.

FIG. 5 is a diagram illustrating the defect detection performed by a defect detection block shown in FIG. 4.

FIG. 6 is a flowchart illustrating a first embodiment of a parameter calibration method employed by the optical storage apparatus shown in FIG. 4.

FIG. 7 is a diagram illustrating an exemplary case where no parameter calibration is enabled when an optical pick-up head accesses a defective area on an optical storage medium.

FIG. 8 is a diagram illustrating an exemplary case where a parameter calibration is enabled when the optical pick-up head accesses a defective area on the optical storage medium.

FIG. 9 is a flowchart illustrating a second embodiment of a parameter calibration method employed by the optical storage apparatus shown in FIG. 4.

FIG. 10 is a diagram illustrating the parameter settings corresponding to a defective area and a normal area according to the parameter calibration method shown in FIG. 6.

FIG. 11 is a diagram illustrating the parameter settings corresponding to a defective area and a normal area according to the parameter calibration method shown in FIG. 9.

FIG. 12 is a block diagram illustrating an optical storage apparatus according to another exemplary embodiment of the present invention.

FIG. 13 is a flowchart illustrating a first embodiment of a parameter calibration method employed by the optical storage apparatus shown in FIG. 12.

FIG. 14 is a flowchart illustrating a second embodiment of a parameter calibration method employed by the optical storage apparatus shown in FIG. 12.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

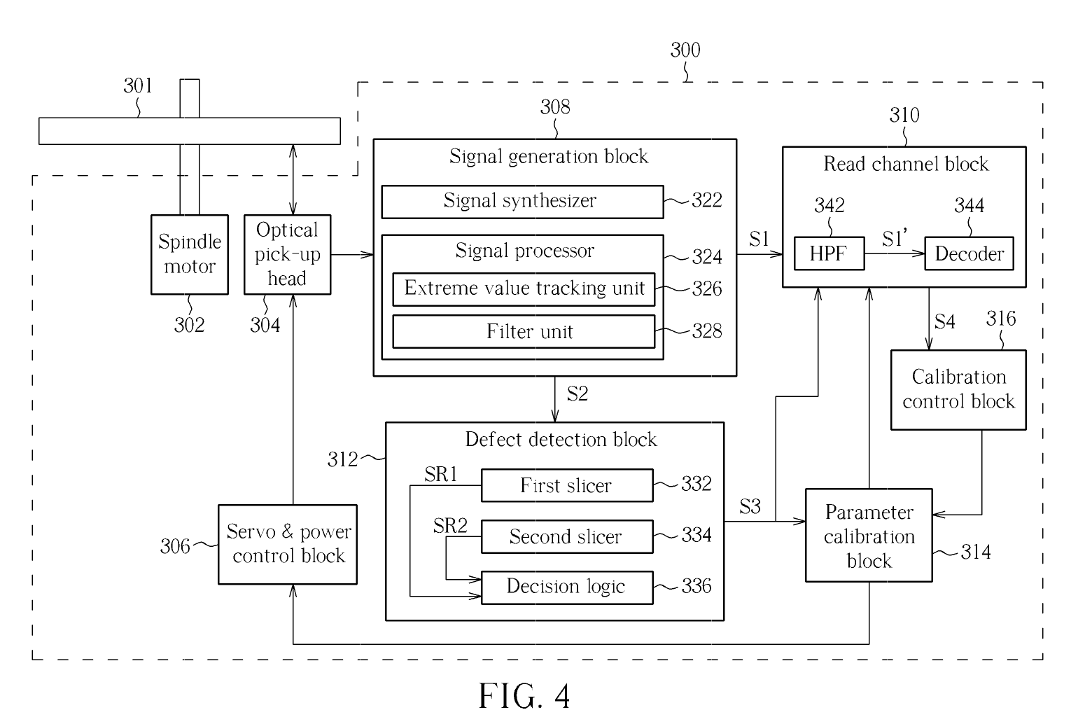

FIG. 4 is a block diagram illustrating an optical storage apparatus according to an exemplary embodiment of the present invention. The exemplary optical storage apparatus 300, such as an optical disc drive, includes a spindle motor 302, an optical pick-up head 304, a servo & power control block 306, a signal generation block 308, a read channel block 310, a defect detection block 312, a parameter calibration block 314, and a calibration control block 316. When an optical storage medium (e.g., an optical disc 301) is loaded into the optical storage apparatus 300, the spindle motor 302 is activated to rotate the optical disc 301 at the desired rotational speed. The optical pick-up head 304 is then operative to emit a laser beam with specific read power onto the optical disc 301 to read data from the optical disc 301. If the optical disc 301 is a recordable or rewritable disc, the optical pick-up head 304 in the optical storage apparatus 300 can be configured to emit a laser beam with specific write power to record data onto the optical disc 301. The operation of the optical pick-up head 304 is controlled by the servo & power control block 306. As details of the servo control mechanism and the power control mechanism applied to the optical pick-up head 304 are well known to those skilled in the art, further description is omitted here for the sake of brevity.

In this embodiment, the signal generation block 308 includes a signal synthesizer 322 and a signal processor 324 including an extreme value tracking unit 326 and a filter unit 328. The signal synthesizer 322 is implemented for generating a readback signal S1, such as a radio frequency (RF) signal, according to signals reflected from the optical disc 301 and then detected by a photo sensor (not shown) in the optical pick-up head 304. The signal processor 324 is implemented for processing the readback signal S1 to generate a processed readback signal (e.g., a processed RF signal) S2. In the signal processor 324, the extreme value tracking unit 326 is used for tracking predetermined-type extreme values of the readback signal S1 to generate an extreme value tracking result, and the filter unit 328 is used for performing a filtering operation upon the extreme value tracking result to generate the processed readback signal S2. In one exemplary implementation, the extreme value tracking unit 326 is implemented using a peak hold circuit for tracking peak values of the readback signal S1, and the filter unit 328 is implemented using a low-pass filter for filtering out high-frequency components in the output of the peak hold circuit. Next, the processed readback signal S2 is fed into the following defect detection block 312 for further signal processing, which is detailed as follows. Please notes that the implementation of signal processor 324 is only an example, and is not meant to be limitations of the present invention. Other implementations of the signal processor 324 for processing the readback signal S1 to generate the processed readback signal for defect detection block 312 may be utilized in accordance with the design necessity.

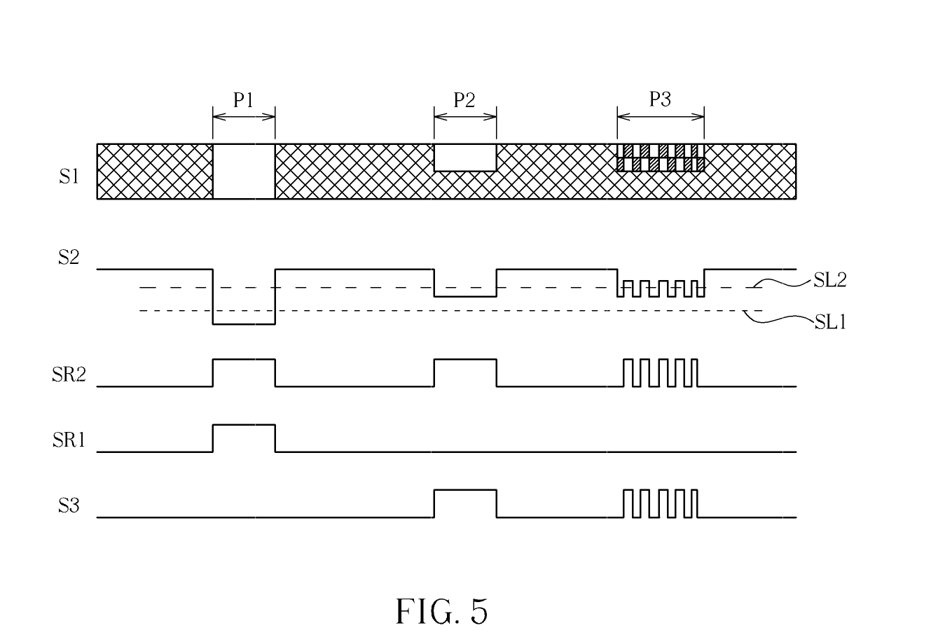

In this exemplary embodiment, the defect detection block 312 includes a first slicer 332, a second slicer 334, and a decision logic 336. The first slicer 332 is implemented for slicing the processed readback signal S2 by a first slicer level SL1 to generate a first slicing result SRI, the second slicer 224 is implemented for slicing the processed readback signal S2 by a second slicer level SL2 to generate a second slicing result SR2, and the decision logic 336 generates the defect detection result S3 according to the first slicing result SR1 and the second slicing result SR2. Please refer to FIG. 5, which is a diagram illustrating the defect detection performed by the defect detection block 312. As mentioned above, when the optical pick-up head 304 is accessing a defective area caused by scratch, the signal portion P1 almost disappears (i.e., the signal amplitude is quite low); and when the optical pick-up head 304 is accessing a defective area caused by fingerprint/dirt, the signal portion P2 or P3 has magnitude smaller than normal one but does not disappear completely (i.e., the signal amplitude is reduced but is still above an acceptable level). Therefore, based on the signal characteristics of the defective areas formed due to scratch and fingerprint/dirt respectively, the first slicer level SL1 is configured to be lower than the second slicer level SL2. The first slicer level SL1 is specifically designed for identifying the defective area caused by the scratch, while the second slicer level SL2 is specifically used for identifying the defective areas caused by either the scratch or the fingerprint/dirt. In this embodiment, the decision logic 336 performs an XOR operation upon the first slicing result SRI and the second slicing result SR2 to thereby generate the defect detection result S3 (i.e., S3=SR1 XOR SR2). As clearly shown in FIG. 5, the defect detection result S3 indicates the defective areas caused by the fingerprint/dirt only. In other words, depending upon the design requirement of a specific application, the decision logic 336 could be configured to discriminate between defective areas caused by scratch and the defective areas caused by fingerprint/dirt according to slicing results generated from the first slicer 332 and the second slicer 334. However, this is not meant to be a limitation of the present invention. That is, any application using one or more slicers to identify the defective areas on an optical storage medium still obeys the spirit of the present invention.

In the exemplary embodiment shown in FIG. 4, the defect detection block 312 includes two individual slicers. However, in one alternative design, the defect detection block 312 is modified to include one slicer and the decision logic 336. During a first period, the slicer uses the first slicing level SL1 to slice the processed readback signal S2 corresponding to a specific track sector. Any defective area found by the first slicing result SR1 is identified by the decision logic 336 as a defective area formed due to scratch. During a second period, the slicer uses the second slicing level SL2 to slice the processed readback signal S2 corresponding to the same specific track sector. Any defective area found by the second slicing result SR2 is identified by the decision logic 336 as a defective area formed due to scratch or fingerprint/dirt. In this way, the same defect detection result could be derived from two sequential slicing operations using the same slicer even through a single slicer is implemented in the defect detection block 312.

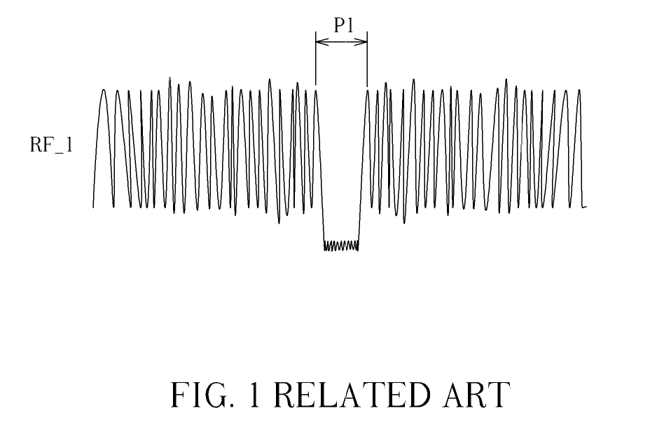

In another alternative design, the defect detection block 312 is modified to include the second slicer 334 and the decision logic 336. That is, the first slicer 332 used for generating a slicing result indicating defective areas caused by scratch is omitted in this alternative design. In this way, the second slicing result SR2 directly serves as the defect detection result S3 generated from the defect detection block 312. Take the implementation of using a high-pass filter to process signal portions in the readback signal (e.g., the RF signal) S1 that correspond to defective areas caused by fingerprint/dirt as an example. The signal portion P1 in FIG. 1 would be identified by the second slicer 334; however, as the signal amplitude of the signal portion P1 is quite small, the high-pass filtering result of the signal portion P1 is almost identical to the non-filtered signal portion P1. In other words, the high-pass filtering result is the same even though the defect detection result is the second slicing result SR2 instead of an combination logic result of the first and second slicing results SR1 and SR2.

It should be noted that above-mentioned alternative embodiments all obey the spirit of the present invention of using one or more slicers to find the defective areas caused by scratch or fingerprint/dirt, and fall with the spirit of the present invention.

Briefly summarized, the defect detection result S3 could be set by a combinational logic result such as an XOR result of the first slicing result SR1 and the second slicing result SR2, the first slicing result SR1, or the second slicing result SR2, depending upon design requirements. For example, in a case where high-pass filtering will be applied to the readback signal S1 for facilitating decoding of the signal portions corresponding to the defective areas, the combinational logic result of the first and second slicing results SR1 and SR2 or the second slicing result SR2 is preferably selected as the defect detection result S3 to indicate when to start adjusting the high-pass filtering operation. Further details are given as below.

The defect detection result S3 generated from the defect detection block 312 is delivered to the parameter calibration block 314. The parameter calibration block 314 is implemented for performing a parameter calibration upon at least one parameter associated with processing of the readback signal S1 according to the incoming defect detection result S3. When the optical pick-up head 304 is accessing a defective area caused by fingerprint/dirt, the parameter calibration block 314 is notified by the defect detection result S3 shown in FIG. 5, and then is enabled to calibrate at least a read channel parameter, at least a servo parameter or a combination thereof, depending upon design requirements. In other words, the parameter calibration block 314 adjusts read channel parameter(s) employed in the read channel block 310 and/or servo parameter(s) employed in the servo & power control block 306. The exemplary read channel parameter could be a slicer bandwidth, a Viterbi bandwidth, a phase-locked loop (PLL) bandwidth, a partial response maximum likelihood (PRML) target level, a decoding strategy, an RF signal high-pass filtering bandwidth, or an RF signal amplitude. With regard to the servo parameter, it could be a focus gain or a defocus setting. Please note that above-mentioned parameter examples are for illustrative purposes only, and are not meant to be limitations of the present invention. Any implementation referring to the defect detection result for selectively enabling a parameter calibration of at least one parameter obeys the spirit of the present invention and falls within the scope of the present invention.

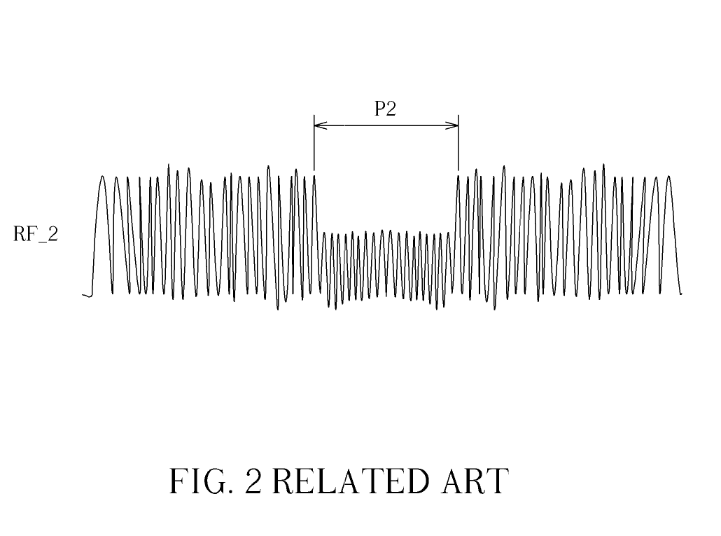

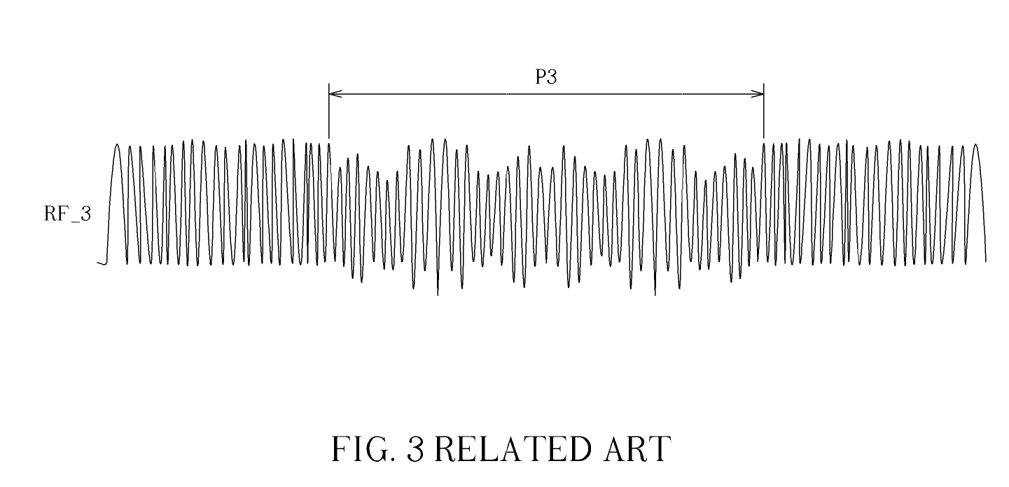

Furthermore, a high-pass filter (HPF) 342 which is one exemplary component generally implemented in the read channel block 310 can also be selectively adjusted for high-pass filtering the readback signal S1 according to the defect detection result S3. In general, the high-pass filter 342 is used to perform high-pass filtering upon an incoming signal when a normal area or a defective area is currently accessed by the optical pick-up head 304; however, in one implementation of the present invention, the filter characteristic of the high-pass filter 342 can also be adjusted when the optical pick-up head 304 is accessing a defective area. For instance, when the optical pick-up head 304 is accessing a defective area caused by, for example, fingerprint/dirt, the high-pass filter 342 is adjusted and performs high-pass filtering upon the readback signal S1 to thereby generate a filtered readback signal S1′, and then a decoder 344 decodes the filtered readback signal S1′ received from the preceding high-pass filter 342. In other words, in one implementation, the high-pass filter 342 can be selectively adjusted and the parameter calibration block 314 is enabled when a defective area identified according to the defect detection result S3 is accessed by the optical pick-up head 304. As clearly shown in FIG. 2 and FIG. 3, the fingerprint/dirt would make the affected signal portion in the readback signal S1 become asymmetrical, which would increase the difficulty in decoding the signal portion corresponding to the defective area formed due to fingerprint/dirt. Therefore, in the exemplary embodiment of the present invention, the high-pass filter 342, which is generally implemented in the read channel block 310 and can be adjusted when the defective areas are accessed, is also capable of making the affected signal portion in the readback signal S1 become more symmetrical, thereby facilitating the decoding of the signal portion corresponding to the defective area caused by fingerprint/dirt. Briefly summarized, the information transmitted by the signal portion P2 or P3 shown in FIG. 5 could be decoded successfully through applying the high-pass filtering to the readback signal S1 and enabling the parameter calibration upon the read channel parameter(s) and/or the servo parameter(s).

Please note that any application selectively adjusting the high-pass filtering applied to the readback signal or applying the parameter calibration to at least one parameter (e.g., the read channel parameter or servo parameter) according to the defect detection result still obeys the spirit of the present invention, and falls within the scope of the present invention.

The calibration control block 316 is implemented in the optical storage apparatus 300 for controlling operation of the parameter calibration block 314 according to a signal quality index S4 derived from the processing of the readback signal S1. For example, the signal quality index S4 could be a signal quality of a synchronization signal derived from the readback signal S1 (e.g., a SYNC_OK signal) or a decoding quality associated with decoding of the readback signal S1 (e.g., an Error Detection Code (EDC) or Identification (ID) decoding OK signal, or a decoding error count). Take the SYNC_OK signal serving as the signal quality index S4 as an example. If the readback signal S1 has signal quality that is good enough, the SYNC signal could be obtained continuously without intermission. That is, the SYNC_OK signal used for indicating the status of the SYNC signal will be kept, for example, at a high logic level. However, when the readback signal S1 fails to have signal quality satisfying the minimum requirement, the SYNC signal will have a sync loss. As a result, the SYNC_OK signal will have a low logic level to indicate such a situation. Due to the specific signal characteristic of the SYNC_OK signal, the SYNC_OK signal therefore could serve as the signal quality index S4 to indicate if the parameter calibration has calibrated the parameter using an optimized parameter setting.

In general, the readback signal (e.g., an RF signal) S1 becomes un-correctable when the decoding error count exceeds a specific value, implying that the readback signal S1 has poor signal quality and it is difficult to correctly decode such a signal. Therefore, when the optical disc 301 is a compact disc (CD), the C2 decoding error count could be used as the signal quality index; when the optical disc 301 is a digital versatile disc (DVD) or a high-definition digital versatile disc (HD-DVD), the PO (Parity of the Outer code) decoding error count could be used as the signal quality index; and when the optical disc 301 is a Blu-ray disc (BD), the Long Distance Code (LDC) decoding error count could be used as the signal quality index. As well known in the pertinent art, the PO decoding for DVD or HD-DVD and the C2 decoding for CD are more sensitive to the signal quality. For example, if the PO decoding error count or C2 decoding error count of a data block is equal to one, it is possible that the quality of the whole data block is bad. It should be noted that even though the Parity of the Inner code (PI) decoding for DVD/HD-DVD and the C1 decoding for CD is not so sensitive to the signal quality, this does not mean that the PI decoding error count/C1 decoding error count cannot be used as the signal quality index. For example, when the PI decoding error count or the C1 decoding error count of a data block is greater than an error accumulation threshold, this implies that there are too many decoding errors in the same data block, and the data block might be un-correctable due to bad signal quality of the readback signal. Therefore, the PI decoding error count or the C1 decoding error count could also be employed as the signal quality index.

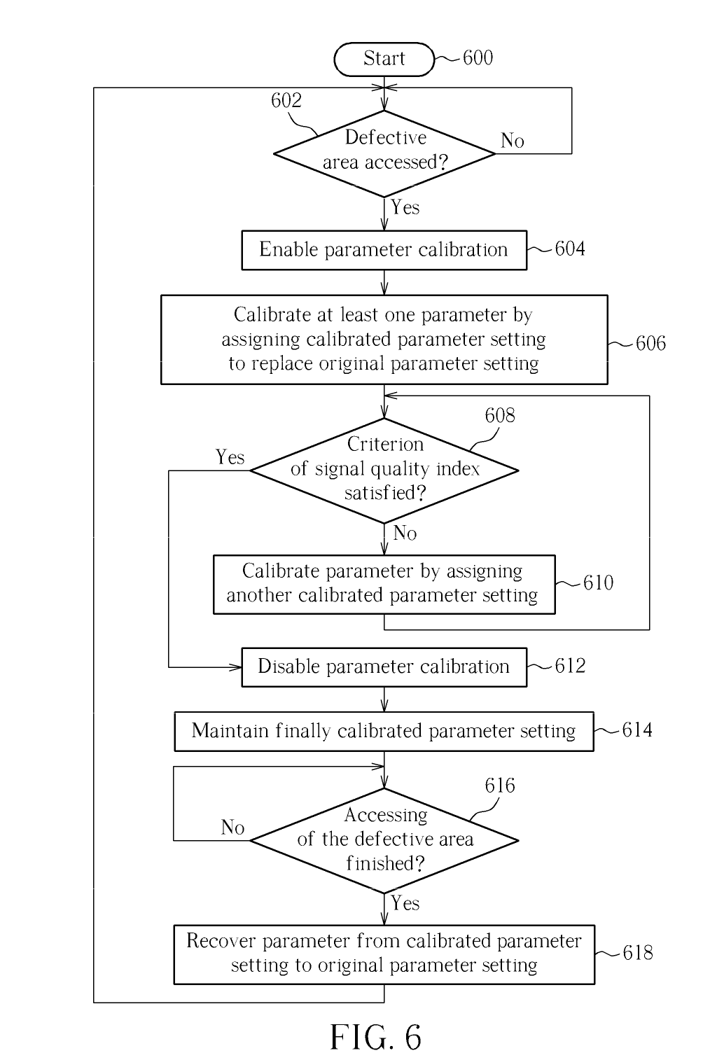

FIG. 6 is a flowchart illustrating a first embodiment of a parameter calibration method employed by the optical storage apparatus 300 shown in FIG. 4. Please note that if the result is substantially the same, the steps are not required to be executed in the exact order shown in FIG. 6. The flow of the parameter calibration operation includes following steps:

Step 600: Start.

Step 602: Check a defect detection result to determine if an optical pick-up head is going to access a defective area on an optical storage medium (e.g., an optical disc). If yes, go to step 604; otherwise, go to step 602 to keep monitoring the defect detection result.

Step 604: Enable a parameter calibration.

Step 606: Calibrate at least one parameter by assigning a calibrated parameter setting to replace an original parameter setting set to the parameter, wherein the at least one parameter could include a read channel parameter, a servo parameter, or a combination thereof.

Step 608: Check if a signal quality index satisfies a predetermined criterion. If yes, go to step 612; otherwise, go to step 610.

Step 610: Calibrate the parameter by assigning another calibrated parameter setting to the parameter. Go to step 608.

Step 612: Disable the parameter calibration.

Step 614: Maintain a finally calibrated parameter setting set to the parameter.

Step 616: Check if the optical pick-up head has finished accessing the defective area. If yes, go to step 618; otherwise, go to step 616 to keep monitoring.

Step 618: Recover the parameter from the calibrated parameter setting that is assigned by the parameter calibration enabled due to accessing of the defective area to the original parameter setting. Go to step 602 to keep monitoring the defect detection result.

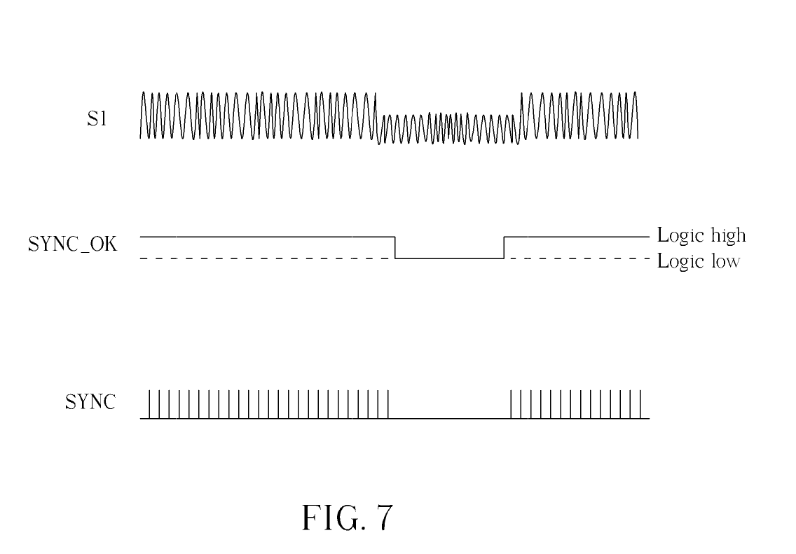

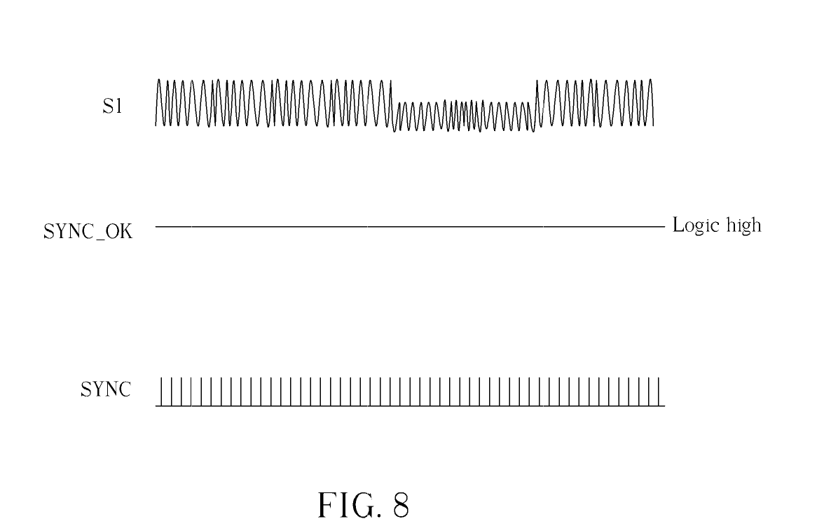

As shown in the flowchart in FIG. 6, the parameter calibration block 314 does not stop calibrating the parameter until the signal quality index satisfies the predetermined criterion. For example, provided that the SYNC_OK signal serves as the signal quality index, the predetermined criterion is satisfied only when the SYNC_OK signal has no sync loss. Please refer to FIG. 7 in conjunction with FIG. 8. FIG. 7 is a diagram illustrating an exemplary case where no parameter calibration is enabled when the optical pick-up head accesses a defective area on the optical storage medium. FIG. 8 is a diagram illustrating an exemplary case where a parameter calibration is enabled when the optical pick-up head accesses a defective area on the optical storage medium. With proper parameter calibration applied to the read channel parameter(s) and/or the servo parameter(s), the readback signal S1 could be correctly decoded to derive information included therein. As the parameter calibration method is employed by the optical storage apparatus 300 shown in FIG. 4, a person skilled in the art could readily understand operations of the parameter calibration method shown in FIG. 6 after reading above paragraphs. Further description is therefore omitted here for the sake of brevity.

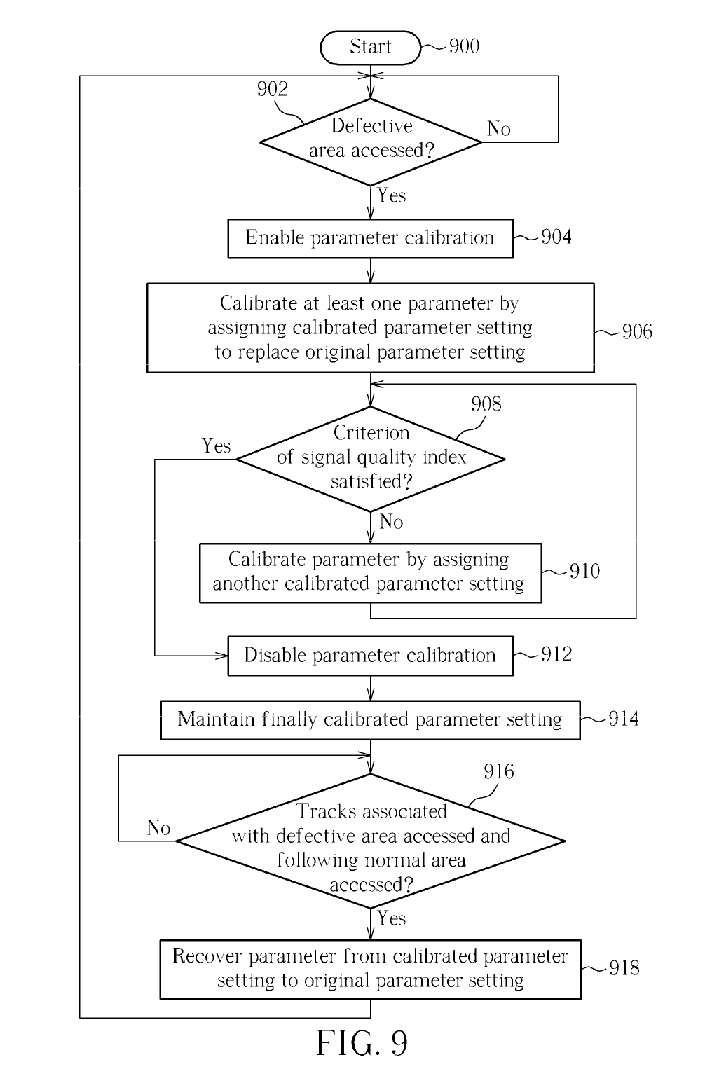

Please refer to FIG. 9, which is a flowchart illustrating a second embodiment of a parameter calibration method employed by the optical storage apparatus 300 shown in FIG. 4. Please note that if the result is substantially the same, the steps are not required to be executed in the exact order shown in FIG. 9. The flow of the parameter calibration operation includes following steps:

Step 900: Start.

Step 902: Check a defect detection result to determine if an optical pick-up head is going to access a defective area on an optical storage medium (e.g., an optical disc). If yes, go to step 904; otherwise, go to step 902 to keep monitoring the defect detection result.

Step 904: Enable a parameter calibration.

Step 906: Calibrate at least one parameter by assigning a calibrated parameter setting to replace an original parameter setting of the parameter, wherein the at least one parameter could include a read channel parameter, a servo parameter, or a combination thereof.

Step 908: Check if a signal quality index satisfies a predetermined criterion. If yes, go to step 912; otherwise, go to step 910.

Step 910: Calibrate the parameter by assigning another calibrated parameter setting to the parameter. Go to step 908.

Step 912: Disable the parameter calibration.

Step 914: Maintain a finally calibrated parameter setting set to the parameter.

Step 916: Check if the optical pick-up head has finished accessing tracks associated with the defective area and then accessed at least a portion of a normal area. If yes, go to step 918; otherwise, go to step 916 to keep monitoring.

Step 918: Recover the parameter from the calibrated parameter setting that is assigned by the parameter calibration enabled due to accessing of the defective area to the original parameter setting. Go to step 902 to keep monitoring the defect detection result.

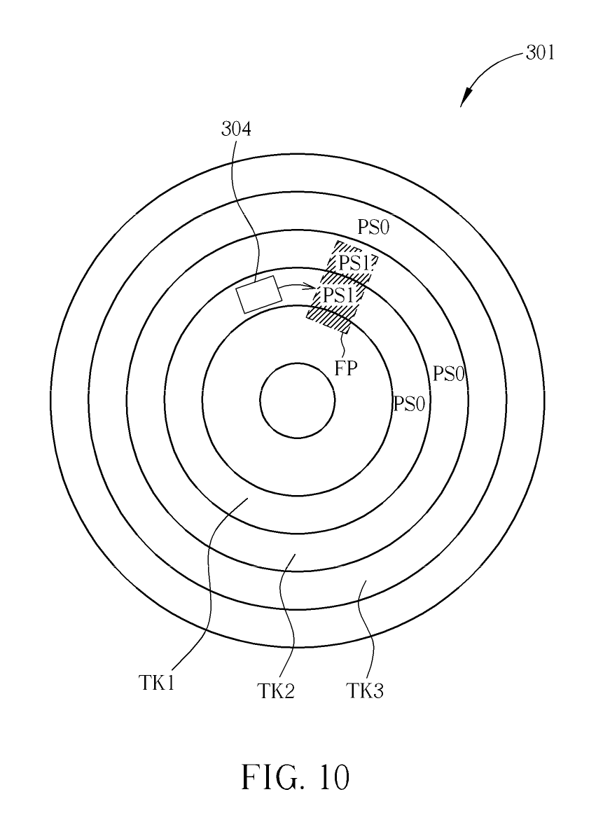

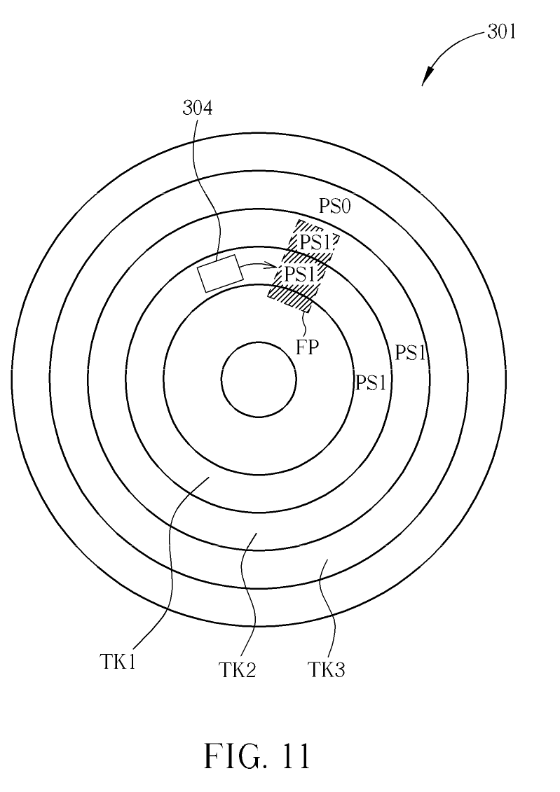

The exemplary parameter calibration method in FIG. 9 is similar to that shown in FIG. 6, and the major difference is the timing of recovering the parameter from the calibrated parameter setting to the original parameter setting (i.e., the parameter setting before the parameter calibration is enabled). Please refer to FIG. 10 in conjunction with FIG. 11. FIG. 10 is a diagram illustrating the parameter settings corresponding to a defective area and a normal area according to the parameter calibration method shown in FIG. 6. FIG. 11 is a diagram illustrating the parameter settings corresponding to a defective area and a normal area according to the parameter calibration method shown in FIG. 9. As shown in FIG. 10 and FIG. 11, there is a fingerprint FP on the surface of the optical disc 301, where two tracks TK1 and TK2 are affected by the fingerprint FP. For simplicity and clarity, the spiral track formed on the optical disc 301 is represented using a plurality of concentric tracks. With regard to the parameter calibration method shown in FIG. 6, the calibrated parameter setting PS1 is valid only when the optical pick-up head 304 is accessing the defective area caused by the fingerprint FP, and the original parameter setting PS0 is employed when the optical pick-up head 304 is accessing the normal area beyond the defective area. Provided that the optical pick-up head 304 accesses the exemplary tracks TK1-TK3 sequentially (i.e., from an inner track TK1 to an outer track TK3), and moves alone the spiral track on the optical disc 301 in a clockwise direction indicated by the arrow symbol illustrated in FIG. 10 and FIG. 11. When the optical pick-up head 304 enters the defective area on the track TK1, the parameter calibration is enabled to find the optimal calibrated parameter setting PS1; however, once the optical pick-up head 304 leaves the defective area, the original parameter setting PS0 is immediately recovered. Similarly, when the optical pick-up head 304 enters the defective area on the track TK2, the parameter calibration is enabled to find the optimal calibrated parameter setting PS1; however, once the optical pick-up head 304 leaves the defective area, the original parameter setting PS0 is immediately recovered. As the external track TK3 is free of any fingerprint, the original parameter setting PS0 is employed when the optical pick-up head 304 is accessing the track TK3.

With regard to the parameter calibration method shown in FIG. 9, the calibrated parameter setting PS1 is maintained after the optical pick-up head 304 leaves the tracks associated with the defective area. For example, the calibrated parameter setting PS1, found during the optical pick-up head 304 accessing the defective area on the track TK1, is still valid when the optical pick-up head 304 accesses a normal area immediately following the defective area on the track TK1. If the defective areas on the optical storage medium could be precisely detected using the defect detection block 312, the parameter calibration method shown in FIG. 6 is employed for achieving optimized performance of reading the defective areas on the optical storage medium; however, if the defective areas on the optical storage medium could not be precisely detected using the defect detection block 312, the parameter calibration method shown in FIG. 9 is preferably employed for achieving optimized performance of reading the defective areas on the optical storage medium. In an exemplary design, the calibrated parameter setting PS1 is valid for at least one track as shown in FIG. 11. As the next track TK2 is still affected by the fingerprint FP, no parameter recovery is performed when the optical pick-up head 304 accesses the track TK2, including a defect area and a normal area. When the optical pick-up head 304 enters the outer track TK3, the parameter recovery is enabled to recover the parameter from the calibrated parameter setting PS1 to the original parameter setting PS0 because the defect detection result S3 generated from the defect detection block 312 will notify the parameter calibration block 314 that that there is no defective area on the track TK3.

Please note that the examples shown in FIG. 10 and FIG. 11 are for illustrative purposes only, and are not meant to be limitations of the present invention. Alternative designs obeying the spirit of the present invention all fall within the scope of the present invention. In addition, as a person skilled in the art could readily understand operations of the parameter calibration method shown in FIG. 9 after reading above paragraphs, further description is therefore omitted here for the sake of brevity.

As mentioned above, the parameter calibration block 314 calibrates the parameter (e.g., a read channel parameter and/or a servo parameter) to find an optimized parameter setting for the defective area accessed by the optical pick-up head 304. In an exemplary embodiment of the present invention, the defect magnitude of the defective area on the optical storage medium could be taken into consideration when the parameter calibration block 314 is enabled to calibrate at least one parameter associated with decoding of the readback signal S1. For example, the parameter calibration block 314 first identifies a defect magnitude of a defective area on the optical storage medium (e.g., the optical disc 301 ) according to the defect detection result S3. When the defect magnitude corresponds to a first level, the parameter calibration block 314 performs the parameter calibration to calibrate a first parameter associated with processing of the readback signal S1; and when the defect magnitude corresponds to a second level, the parameter calibration block 314 performs the parameter calibration to calibrate a second parameter associated with processing of the readback signal S1. In other words, the parameter to be calibrated is dynamically selected according to the defect magnitude. In an alternative implementation, the parameter calibration block 314 performs the parameter calibration to calibrate a parameter by a first parameter setting when the defect magnitude corresponds to a first level, and performs the parameter calibration to calibrate the parameter by a second parameter setting when the defect magnitude corresponds to a second level. In other words, the parameter setting assigned to the parameter to be calibrated is dynamically determined according to the defect magnitude.

When the defect magnitude is taken into consideration, the calibration time spent on finding the optimum calibrated parameter setting could be shortened due to the fact that the defect magnitude offers additional information for the parameter calibration. Please note that the aforementioned examples are for illustrative purposes only, and are not meant to be limitations of the present invention. For example, with the help of the signal quality index, the parameter calibration could employ a try-and-error methodology or other searching algorithm to find the optimum calibrated parameter setting. The same objective of finding an optimized parameter setting is achieved.

In addition to performing the parameter calibration to find the calibrated parameter setting satisfying the requirement, embodiments of the present invention also propose storing the calibrated parameter setting which includes setting values for one or more parameters associated with processing of a readback signal to improve the reading performance of an optical storage apparatus, such as an optical disc drive. For example, the setting value(s) for at least a read channel parameter (e.g., a slicer bandwidth, a Viterbi bandwidth, a PLL bandwidth, a PRML target level, a decoding strategy, an RF signal high-pass filtering bandwidth, or an RF signal amplitude), at least a servo parameter (e.g., a focus gain or a defocus setting) or a combination thereof are derived using the parameter calibration and then stored in a storage for later use. Preferably, a plurality of parameters are calibrated to make the optical storage apparatus have optimized reading performance, which also resulting in a longer period of time spent on completing the first-time parameter calibration for a loaded optical storage medium (e.g., an optical disc). However, as the calibrated parameter setting for the optical storage medium has been recorded in the optical storage apparatus, the optical storage apparatus therefore can employ the calibrated parameter setting stored therein to improve the signal quality of the readback signal to be decoded when the same optical storage medium is loaded into the optical storage apparatus again. In other words, the parameter calibration, which is enabled to calibrate a plurality of parameters associated with reading data from an optical storage medium when the signal quality of the readback signal fails to meet the requirement due to defective areas on the optical storage medium, might cause a playback interrupt perceivable to the viewer; however, after the calibrated parameter setting for these parameters is derived and stored, the following playback of the same optical storage medium loaded into the optical storage apparatus again would become smooth with the help of the stored calibrated parameter setting derived by the previous parameter calibration. Detailed operation is illustrated as follows.

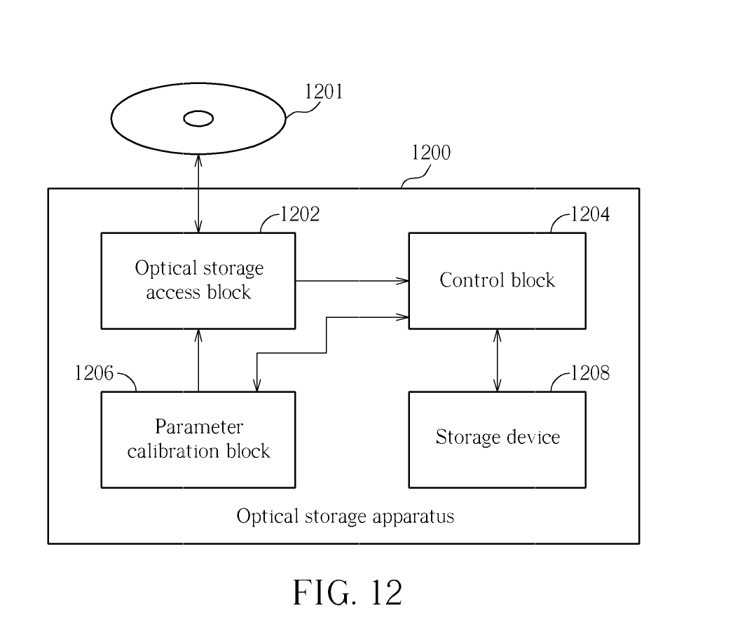

FIG. 12 is a block diagram illustrating an optical storage apparatus according to another exemplary embodiment of the present invention. The optical storage apparatus 1200, such as an optical disc drive, includes an optical storage access block 1202, a control block 1204, a parameter calibration block 1206, and a storage device 1208. When an optical storage medium (e.g., an optical disc 1201) is loaded into the optical storage apparatus 1200, the optical storage access block 1202 is operative to access information recoded on the optical disc 1201. For example, the optical storage access block 1202 includes, but is not limited to, a spindle motor (e.g., the spindle motor shown in FIG. 4) for rotating the optical disc 1201 at the desired rotational speed, an optical pick-up head (e.g., the optical pick-up head shown in FIG. 4) for emitting a laser beam with specific read power onto the optical disc 1201 and detecting reflected laser beam, a servo & power control block (e.g., the servo & power control block 306 shown in FIG. 4) for controlling the operation of the optical pick-up head, a signal synthesizer (e.g., the signal synthesizer 322 shown in FIG. 4) for generating a readback signal (e.g., an RF signal) according to signals which are reflected from the optical disc 1201 and then detected by a photo sensor (not shown) in the optical pick-up head, and a read channel block (e.g., the read channel block 310 shown in FIG. 4) for performing high-pass filtering upon the readback signal to thereby generate a filtered readback signal and then decoding the filtered readback signal to derive information stored on the optical disc 1201. In addition, if the aforementioned parameter calibration mechanism is employed by the optical storage apparatus 1200, the optical storage access block 1202 further includes additional components, such as the extreme value tracking unit 326 and the filter unit 328 shown in FIG. 4. As the optical storage access block 1202 is capable of retrieving information stored on the optical disc 1201, the optical storage access block 1202 in this embodiment also derives identification information of the optical disc 1201 from the readback signal. For example, the identification information is derived from a table of content, a control data zone, or a file system unique signature of the optical disc 1201.

The parameter calibration block 1206 is implemented for performing a parameter calibration upon at least one parameter associated with processing of the readback signal to thereby derive a calibrated parameter setting. If the aforementioned parameter calibration mechanism is employed by the optical storage apparatus 1200, the parameter calibration block 1206 can be implemented using the parameter calibration block 314 shown in FIG. 4.

The control block 1204 is configured to activate the parameter calibration block 1206 when a specific condition is met (e.g., when the signal quality is lower than an acceptable level due to accessing a defective area on the optical disc 1201), and records the identification information of the optical disc 1201 and the calibrated parameter setting found by the parameter calibration block 1206 for the optical disc 1201 into the storage device 1208 (e.g., a memory device or other component with data storage capability). That is, the control block 1204 records the calibrated parameter setting indexed by the identification information of the optical disc 1201 in the storage device 1208 for later use. Similarly, if the aforementioned parameter calibration mechanism is employed by the optical storage apparatus 1200, the calibration control block 316 and the defect detection block 312 in FIG. 4 are implemented in the control block 1204.

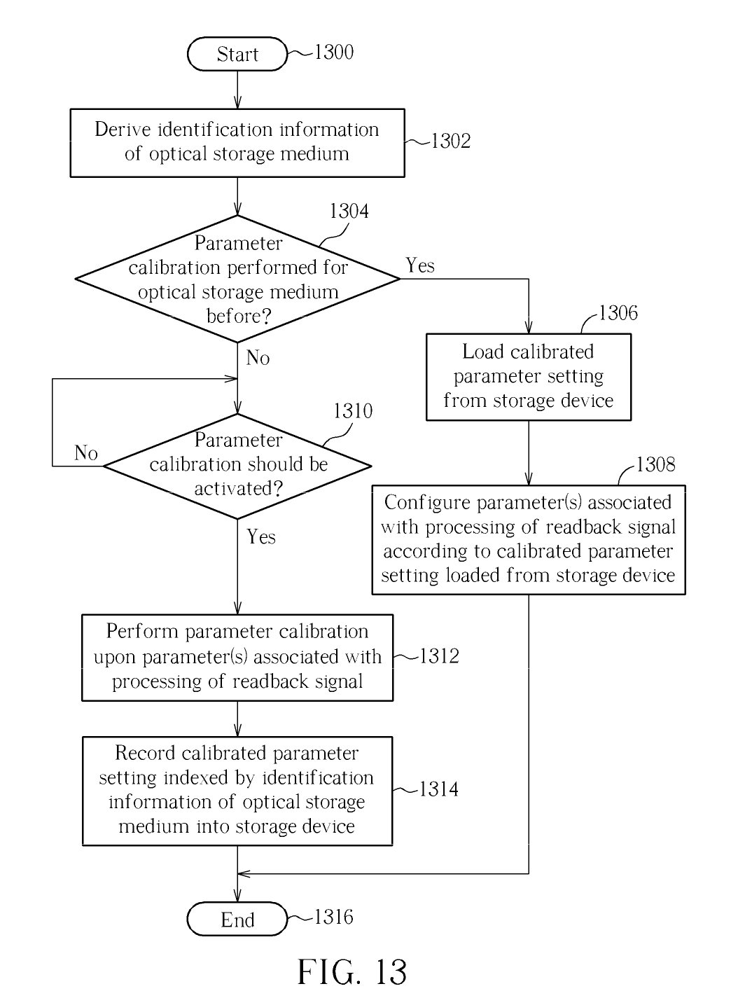

FIG. 13 is a flowchart illustrating a first embodiment of a parameter calibration method employed by the optical storage apparatus 1200 shown in FIG. 12. Please note that if the result is substantially the same, the steps are not required to be executed in the exact order shown in FIG. 13. The flow of the first exemplary parameter calibration operation includes following steps:

Step 1300: Start.

Step 1302: Derive identification information of an optical storage medium.

Step 1304: Refer to the identification information to check if the parameter calibration has been performed for the optical storage medium at least once. If yes, go to step 1306; otherwise, go to step 1310.

Step 1306: Load a calibrated parameter setting from a storage device according to the identification information.

Step 1308: Configure at least one parameter associated with processing of the readback signal according to the calibrated parameter setting loaded from the storage device. Go to step 1316.

Step 1310: Check if the parameter calibration should be activated. If yes, go to step 1312; otherwise, keep checking if the parameter calibration should be activated.

Step 1312: Perform the parameter calibration upon at least one parameter associated with processing of the readback signal, thereby deriving the calibrated parameter setting for the optical storage medium.

Step 1314: Record the calibrated parameter setting indexed by the identification information of the optical storage medium into the storage device.

Step 1316: End.

In most cases, the identification information of an optical storage medium is unique. Therefore, when the optical disc 1201 is loaded, the identification information derived from a table of content, a control data zone, or a file system unique signature of the optical disc 1201 is used by the control block 1204 to check if the parameter calibration block 1206 has performed the parameter calibration for the optical disc 1201 at least once (steps 1302 and 1304). Specifically, in a case where the parameter calibration block 1206 is activated by the controller block 1204 to perform the parameter calibration upon at least one parameter associated with processing of the readback signal derived from reading the optical disc 1201, a calibrated parameter setting is derived (step 1312). Next, the control block 1204 records the calibrated parameter setting indexed by the identification information into the storage device 1208 (step 1314). Therefore, by comparing the identification information of the optical disc 1201 with identification information recorded in the storage device 1208, the control block 1204 is able to know whether the parameter calibration block 1206 has performed the parameter calibration for the optical disc 1201 before. When the control block 1204 finds that the parameter calibration block 1206 has performed the parameter calibration for the optical disc 1201 at least once, meaning that the storage device 1208 should contain the calibrated parameter setting for the optical disc 1201, the control block 1204 therefore loads the calibrated parameter setting for the optical disc 1201 from the storage device 1208, and configures one or more parameters of the optical storage access block 1202 that are associated with processing the readback signal by the calibrated parameter setting loaded from the storage device 1208 regardless of which area of the optical disc 1201 is accessed now or when the calibrated parameter setting is requested due to poor signal quality of the readback signal which causes decode errors or high symbol error rate. For example, in one implementation, the calibrated parameter setting loaded from the storage device 1208 are employed by the optical storage access block 1202 when the optical storage apparatus 1200 accesses any of defective areas and normal areas of the optical disc 1201; however, in another implementation, the calibrated parameter setting loaded from the storage device 1208 are employed by the optical storage access block 1202 only when the optical storage apparatus 1200 accesses defective areas of the optical disc 1201.

When the control block 1204 finds that the parameter calibration block 1206 has not performed the parameter calibration for the optical disc 1201 yet, meaning that the storage device 1208 has no calibrated parameter setting for the optical disc 1201, the control block 1204 checks if the parameter calibration should be activated (steps 1304 and 1310). For example, when the optical storage apparatus 1200 is going to access a defective area on the optical disc 1201 or the signal quality of the readback signal is poor (i.e., the decode error occurs or the symbol error rate is higher than an acceptable level), the control block 1204 activates the parameter calibration block 1206 to perform the parameter calibration upon one or more parameters associated with processing of the readback signal to thereby derive a calibrated parameter setting, and then the control block 1204 records the calibrated parameter setting indexed by the identification information of the optical disc 1201 into the storage device 1208 (steps 1312 and 1314).

If the aforementioned parameter calibration mechanism is employed, step 1310 can be implemented using step 602 shown in FIG. 6, and step 1312 can be implemented using steps 604-612 shown in FIG. 6. In such an implementation, the parameter calibration is stopped once the signal quality index meets a criterion. Next, the calibrated parameter setting is stored into the storage device for later use. However, the parameter calibration in step 1310 is not limited to such an exemplary implementation. For example, the optical storage access block 1202 includes N parameters P₁-P_{N} that are associated with processing of the readback signal. The parameter calibration block 1206 can be configured to find an optimum setting for each of the parameters P₁-P_{N}. In one implementation, the control block 1204 selects all of the optimum settings of the parameters P₁-P_{N} to be the calibrated parameter setting to be recorded into the storage device 1208; in an alternative implementation, the control block 1204 selects part of the optimum settings of the parameters P₁-P_{N} to be the calibrated parameter setting to be recorded into the storage device 1208. For example, only the parameters P₁, P₃ and P_{N-1} have significant improvement in the signal quality; therefore, the control block 1204 merely selects the optimum settings of the parameters P₁, P₃ and P_{N-1} to be the calibrated parameter setting to be recorded into the storage device 1208.

In addition, the parameter calibration block 1206 preferably calibrates one or more parameters associated with processing of the readback signal through checking the signal quality for the same data segment (e.g., the same ECC block or the same track) on the optical disc 1201 to avoid signal quality misjudgment.

Furthermore, the address of the disc area upon which the parameter calibration block 1206 performs the parameter calibration can be recorded as well. In this way, when the optical disc 1201 is loaded into the optical storage apparatus 1200 again, the control block 1204 configures one or more parameters of the optical storage access block 1202 according to a calibrated parameter setting selected according to address of a defective area accessed by the optical storage access block 1202 now. For example, the optical disc 1201 might have a plurality of defective areas formed thereon, the address data and calibrated parameter setting of each defective area are recorded into the storage device 1208. In an alternative design, the optical disc 1201 is virtually divided into a plurality of disc areas, and the address data and calibrated parameter setting for each disc area are recorded into the storage device 1208.

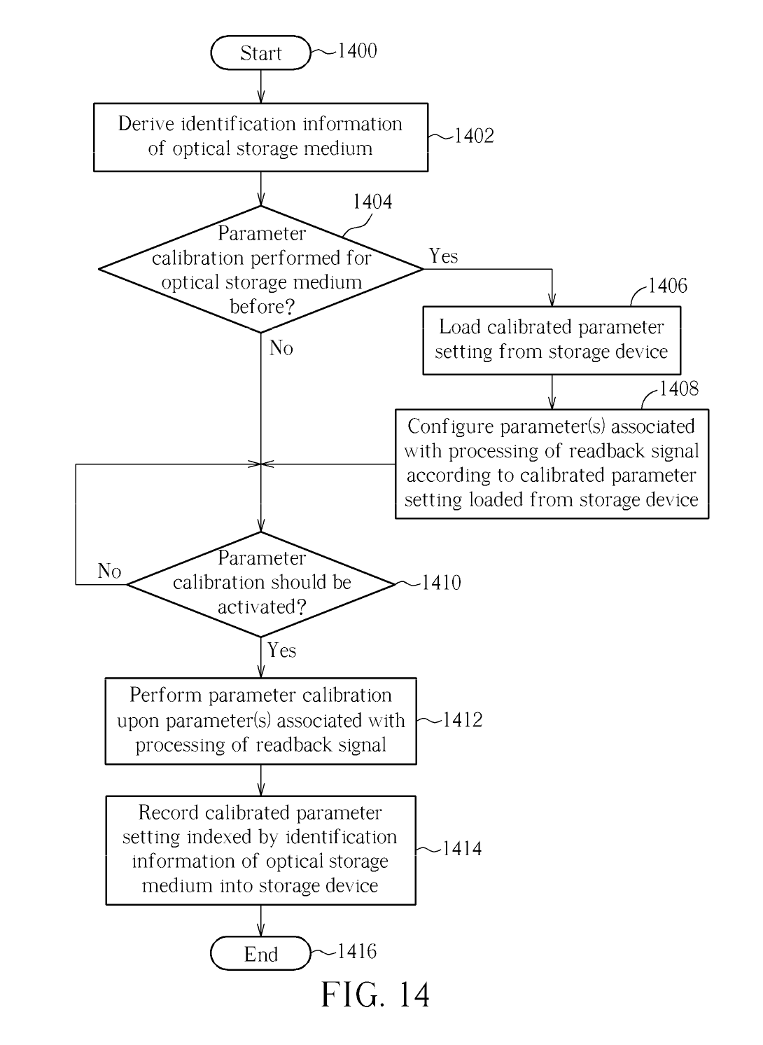

In the exemplary embodiment shown in FIG. 13, the calibrated parameter setting loaded from the storage device 1208 is directly used to configure one or more parameters of the optical storage access block 1202 without further parameter tuning applied thereto. The present further proposes an alternative design which initializes at least one parameter associated with processing of the readback signal by the calibrated parameter setting loaded from the storage device 1208, performs the parameter calibration to thereby update the calibrated parameter setting, and records the new calibrated parameter setting to thereby update the old calibrated parameter setting indexed by the identification information of the optical disc 1201 in the storage device 1208. In this way, even though the calibrated parameter setting found in the previous round of the parameter calibration is not optimum, the current round of the parameter calibration can quickly find a better calibrated parameter setting due to the fact that the calibrated parameter setting found in the previous round of the parameter is used to serve as an initial parameter setting when the current round of the parameter calibration begins. FIG. 14 is a flowchart illustrating a second embodiment of a parameter calibration method employed by the optical storage apparatus 1200 shown in FIG. 12. Please note that if the result is substantially the same, the steps are not required to be executed in the exact order shown in FIG. 14. The flow of the second exemplary parameter calibration operation includes following steps:

Step 1400: Start.

Step 1402: Derive identification information of an optical storage medium.

Step 1404: Refer to the identification information to check if the parameter calibration has been performed for the optical storage medium at least once. If yes, go to step 1406; otherwise, go to step 1410.

Step 1406: Load a calibrated parameter setting from a storage device according to the identification information.

Step 1408: Configure at least one parameter associated with processing of the readback signal according to the calibrated parameter setting loaded from the storage device.

Step 1410: Check if the parameter calibration should be activated. If yes, go to step 1412; otherwise, keep checking if the parameter calibration should be activated.

Step 1412: Perform the parameter calibration upon at least one parameter associated with processing of the readback signal, thereby deriving the calibrated parameter setting for the optical storage medium.

Step 1414: Record the calibrated parameter setting indexed by the identification information into the storage device.

Step 1416: End.

As a person skilled in the art can readily understand details of each step shown in FIG. 13 after reading above paragraphs directed to the exemplary flow shown in FIG. 13, further description is therefore omitted for brevity.

Briefly summarized, the conception of the exemplary apparatus shown in FIG. 12 and exemplary methods shown in FIG. 13 and FIG. 14 is to store the calibrated parameter setting of one or more parameters associated with processing of the readback signal, thereby saving the time spent upon calibrating the parameters when the same optical storage medium is loaded for playback again. It should be noted that the parameter calibration performed by the parameter calibration block 1206 is not limited to these exemplary implementations mentioned above. The parameter calibration block 1206 can be configured to employ any feasible parameter calibration scheme as long as the calibrated parameter setting capable of improving the reading performance of the optical storage apparatus 1200 can be derived successfully. More specifically, no matter what parameter calibration scheme is actually employed to derive a calibrated parameter setting of one or more parameters associated with processing of the readback signal, any optical storage apparatus which records the calibrated parameter setting indexed by the identification information of the optical storage medium into a storage device obeys the spirit of the present invention and falls within the scope of the present invention.

Those skilled in the art will readily observe that numerous modifications and alterations of the device and method may be made while retaining the teachings of the invention.

What is claimed is:

1. A method of processing a readback signal generated from reading an optical storage medium, the method comprising:
performing a defect detection according to the readback signal to generate a defect detection result utilized for indicating defective areas on the optical storage medium; and
performing a parameter calibration upon at least a parameter associated with processing of the readback signal according to the defect detection result.

2. The method of claim 1, wherein performing the defect detection according to the readback signal comprises:
processing the readback signal to generate a processed readback signal;
slicing the processed readback signal by a first slicer level to generate a first slicing result; and
generating the defect detection result according to at least the first slicing result.

3. The method of claim 2, wherein performing the defect detection according to the readback signal further comprises:
slicing the processed readback signal by a second slicer level to generate a second slicing result; and
generating the defect detection result according to at least the first slicing result comprises:
generating the defect detection result according to the first slicing result and the second slicing result.

4. The method of claim 1, wherein the at least the parameter is one of a read channel parameter, a servo parameter, and a combination thereof.

5. The method of claim 4, wherein the read channel parameter is a slicer bandwidth, a Viterbi bandwidth, a phase-locked loop (PLL) bandwidth, a partial response maximum likelihood (PRML) target level, a decoding strategy, an RF signal high-pass filtering bandwidth, or an RF signal amplitude; and the servo parameter is a focus gain or a defocus setting.

6. The method of claim 1, wherein performing the parameter calibration upon at least the parameter comprises:
identifying a defect magnitude of a defective area on the optical storage medium according to the defect detection result; and
performing the parameter calibration according to the defect magnitude.

7. The method of claim 1, further comprising:
controlling the parameter calibration according to a signal quality index derived from the processing of the readback signal.

8. The method of claim 7, wherein controlling the parameter calibration according to the signal quality index comprises:
checking if the signal quality index satisfies a predetermined criterion;
when the signal quality index satisfies the predetermined criterion, disabling the parameter calibration; and
when the signal quality index does not satisfy the predetermined criterion, controlling the parameter calibration to adjust the parameter.

9. The method of claim 7, wherein the signal quality index includes a signal quality of a synchronization signal derived from the readback signal or a decoding quality associated with decoding of the readback signal.

10. The method of claim 1, wherein performing the parameter calibration upon at least the parameter comprises:
identifying a defective area on the optical storage medium according to the defect detection result; and
when accessing the defective area identified according to the defect detection result, enabling the parameter calibration to calibrate the parameter; and
the method further comprises:
once the defective area is not accessed, recovering the parameter from a calibrated parameter setting that is assigned by the parameter calibration enabled due to accessing of the defective area to an original parameter setting.

11. The method of claim 1, wherein performing the parameter calibration upon at least the parameter comprises:
identifying a defective area on the optical storage medium according to the defect detection result; and
when accessing the defective area identified according to the defect detection result, enabling the parameter calibration to calibrate the parameter; and
the method further comprises:
when tracks of the optical storage medium associated with the defective area is not accessed and at least a portion of a normal area is accessed, recovering the parameter from a calibrated parameter setting that is assigned by the parameter calibration enabled due to accessing of the defective area to an original parameter setting.

12. An apparatus for processing a readback signal generated from reading an optical storage medium, the apparatus comprising:
a defect detection block, for performing a defect detection according to the readback signal to generate a defect detection result utilized for indicating defective areas on the optical storage medium; and
a parameter calibration block, coupled to the defect detection block, for performing a parameter calibration upon at least a parameter associated with processing of the readback signal according to the defect detection result.

13. The apparatus of claim 12, further comprising:
a signal generation block, comprising:
a signal synthesizer, for generating the readback signal according to signals reflected from the optical storage medium; and
a signal processor, coupled to the signal synthesizer, for processing the readback signal to generate a processed readback signal;
wherein the defect detection block comprises:
a first slicer, coupled to the signal generation block, for slicing the processed readback signal by a first slicer level to generate a first slicing result; and
a decision logic, coupled to the first slicer, for generating the defect detection result according to at least the first slicing result.

14. The apparatus of claim 13, wherein the defect detection block further comprises:
a second slicer, coupled to the signal generation block and the decision logic, for slicing the processed readback signal by a second slicer level to generate a second slicing result, wherein the decision logic generates the defect detection result according to the first slicing result and the second slicing result.

15. The apparatus of claim 12, wherein the at least the parameter calibrated by the parameter calibration block is one of a read channel parameter, a servo parameter, and a combination thereof.

16. The apparatus of claim 15, wherein the read channel parameter is a slicer bandwidth, a Viterbi bandwidth, a phase-locked loop (PLL) bandwidth, a partial response maximum likelihood (PRML) target level, a decoding strategy, an RF signal high-pass filtering bandwidth, or an RF signal amplitude; and the servo parameter is a focus gain or a defocus setting.

17. The apparatus of claim 12, wherein the parameter calibration block identifies a defect magnitude of a defective area on the optical storage medium according to the defect detection result; and performs the parameter calibration according to the defect magnitude.

18. The apparatus of claim 12, further comprising:
a calibration control block, coupled to the parameter calibration block, for controlling the parameter calibration block according to a signal quality index derived from the processing of the readback signal.

19. The apparatus of claim 18, wherein the calibration control block checks if the signal quality index satisfies a predetermined criterion; disables the parameter calibration block when the signal quality index satisfies the predetermined criterion; and controls the parameter calibration block to adjust the parameter when the signal quality index does not satisfy the predetermined criterion.

20. The apparatus of claim 18, wherein the signal quality index includes a signal quality of a synchronization signal derived from the readback signal or a decoding quality associated with decoding of the readback signal.

21. The apparatus of claim 12, wherein the parameter calibration block identifies a defective area on the optical storage medium according to the defect detection result, and calibrates the parameter when the defective area identified according to the defect detection result is accessed; and once the defective area is not accessed, the parameter calibration block recovers the parameter from a calibrated parameter setting that is assigned by the parameter calibration block enabled due to accessing of the defective area to an original parameter setting.

22. The apparatus of claim 12, wherein the parameter calibration block identifies a defective area on the optical storage medium according to the defect detection result, and calibrates the parameter when the defective area identified according to the defect detection result is accessed; and when tracks of the optical storage medium associated with the defective area is not accessed and at least a portion of a normal area is accessed, the parameter calibration block recovers the parameter from a calibrated parameter setting that is assigned by the parameter calibration block enabled due to accessing of the defective area to an original parameter setting.

23. A method of processing a readback signal generated from reading an optical storage medium, the method comprising:
deriving identification information of the optical storage medium according to the readback signal;
performing a parameter calibration upon at least one parameter associated with processing of the readback signal, thereby deriving a calibrated parameter setting of the at least one parameter; and
recording the calibrated parameter setting indexed by the identification information into a storage device.

24. The method of claim 23, further comprising:
referring to the identification information to check if the parameter calibration has been performed for the optical storage medium at least once; and
when the parameter calibration has been performed for the optical storage medium at least once, loading the calibrated parameter setting from the storage device according to the identification information, and configuring the at least one parameter associated with processing of the readback signal according to the calibrated parameter setting loaded from the storage device;
wherein the step of performing the parameter calibration and the step of recording the calibrated parameter setting are executed when the parameter calibration has not been performed for the optical storage medium yet.

25. The method of claim 24, wherein configuring the at least one parameter associated with processing of the readback signal according to the calibrated parameter setting loaded from the storage device further comprises:
when the parameter calibration is requested, executing the step of performing the parameter calibration to thereby update the calibrated parameter setting loaded from the storage device, and executing the step of recording the calibrated parameter setting to thereby update the calibrated parameter setting indexed by the identification information in the storage device.

26. An apparatus for processing a readback signal generated from reading an optical storage medium, the apparatus comprising:
an optical storage access block, for reading the optical storage medium to derive the readback signal and deriving identification information of the optical storage medium according to the readback signal;
a parameter calibration block, coupled to the optical storage access block, for performing a parameter calibration upon at least one parameter associated with processing of the readback signal, thereby deriving a calibrated parameter setting of the at least one parameter;
a storage device; and
a control block, coupled to the calibration block, the optical storage access block and the storage device, for recording the calibrated parameter setting indexed by the identification information into the storage device.

27. The apparatus of claim 26, wherein the control block further refers to the identification information to check if the parameter calibration block has performed the parameter calibration for the optical storage medium at least once; when the parameter calibration block has performed the parameter calibration for the optical storage medium at least once, the control block loads the calibrated parameter setting indexed by the identification information from the storage device, and configures the at least one parameter associated with processing of the readback signal according to the calibrated parameter setting loaded from the storage device; and when the parameter calibration block has not performed the parameter calibration for the optical storage medium yet, the control block activates the parameter calibration block to perform the parameter calibration for the optical storage medium, and records the calibrated parameter setting derived by the parameter calibration block and indexed by the identification information of the optical storage medium into the storage device.

28. The apparatus of claim 27, wherein when the parameter calibration is requested after the at least one parameter associated with processing of the readback signal is configured according to the calibrated parameter setting loaded from the storage device, the control block further controls the parameter calibration block to perform the parameter calibration to thereby update the calibrated parameter setting loaded from the storage device, and records the updated calibrated parameter setting into the storage device to thereby update the calibrated parameter setting indexed by the identification information in the storage device.
